(19) United States
(12) Patent Application Publication
(10) Pub. No.: US 2025/0242252 A1
(43) Pub. Date: Jul. 31, 2025

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Atsushi UENO, Kyoto (JP); Akane YOSHIDA, Kyoto (JP)

(21) Appl. No.: 19/040,160

(22) Filed: Jan. 29, 2025

(30) Foreign Application Priority Data
Jan. 30, 2024 (JP) 2024-011601

(51) Int. Cl. A63F 13/57

(52) U.S. Cl. CPC A63F 13/57

(57) ABSTRACT

An example of an information processing system determines parameters of a position, a rotation, and a scale for each of a plurality of parts. The information processing system generates a composite object including a first part and a second part. The first part has a shape obtained by combining the plurality of parts placed in a virtual space, based on the parameters. The second part is placed at a reference position in the virtual space and is different from the first part. The information processing system determines the parameters such that the reference position is not shielded by the first part on a side in a reference direction of the composite object.

### CROSS REFERENCE TO RELATED APPLICATION

This application claims priority to Japanese Patent Application No. 2024-011601, filed on Jan. 30, 2024, the entire contents of which are incorporated herein by reference.

### FIELD

The technique shown here relates to a storage medium, an information processing system, an information processing apparatus, and an information processing method for generating an object to be arranged in a virtual space.

### BACKGROUND AND SUMMARY

Conventionally, there is a technique of generating a character by combining a plurality of parts, thereby generating a plurality of types of characters. For example, there is a technique of preparing parts such as face contours, eyes, noses, and mouths, and combining parts to generate a plurality of types of characters.

In the above technique, since parts such as eyes, a nose, and a mouth are placed at positions predetermined with respect to a contour, there is a limitation on patterns of generated characters.

Therefore, the present application discloses a storage medium, an information processing system, an information processing apparatus, and an information processing method that can generate a variety of objects by using a plurality of parts.

(1)

An example of one or more non-transitory computer-readable storage medium having stored therein instructions that, when executed, cause one or more processors of an information processing apparatus to execute information processing comprising: determining parameters of a position, a rotation, and a scale for each of a plurality of parts; and generating a composite object including a first part and a second part, the first part having a shape obtained by combining the plurality of parts placed in a virtual space based on the parameters, the second part being placed at a reference position in the virtual space and being different from the first part. The parameters are determined such that the reference position is not shielded by the first part on a side in a reference direction of the composite object.

According to the configuration of the above (1), since the first part is generated by using the parts for which the parameters are changed to various values, a variety of objects can be generated.

(2)

The parameters may be determined such that the reference position is located at a surface of the first part.

According to the configuration of the above (2), it is possible to reduce a risk that the object looks unnatural because the second part is embedded in the first part and becomes invisible, or the second part is placed apart from the first part.

(3)

The virtual space may be a three-dimensional space. Each of the plurality parts may have a flat surface portion. The parameter of the position and the parameter of the scale may be determined such that a flat surface including the reference position and the surface portions of the plurality of parts are located within the same plane. The parameter of the rotation may be determined such that the surface portions are perpendicular to the reference direction and face the side in the reference direction.

According to the configuration of the above (3), since the second part can be placed on a surface formed by the surface portions of the respective parts, it is possible to reduce the risk that the object looks unnatural.

(4)

For each of the plurality of parts, the parameters may be determined within a range that is set in advance such that the reference position is not shielded by the first part on the side in the reference direction of the composite object.

According to the configuration of the above (4), it is possible to reduce the risk that the object looks unnatural.

(5)

At least one of the parameters may be determined based on probability.

According to the configuration of the above (5), it is possible to generate an object in which the shape of the first part changes at random.

(6)

A process of determining the parameters based on probability may be repeatedly executed until the parameters are determined such that the reference position is not shielded by the first part on the side in the reference direction of the composite object.

According to the configuration of the above (6), it is possible to reduce the risk that the object looks unnatural, and generate an object in which the shape of the first part changes at random.

(7)

The parameters may be determined during execution of a game. The composite object may be placed in the virtual space during execution of the game.

According to the configuration of the above (7), it is possible to generate an object having a different shape each time the game is executed.

(8)

The plurality of parts, and the first part of the composite object may be voxel objects generated based on voxel data.

According to the configuration of the above (8), the process of generating the first part based on the parts can be easily executed by using the voxel data.

(9)

The composite object may be a non-player character.

According to the configuration of the above (9), non-player characters having individual characteristics can be made to appear in the game.

(10)

The storage medium may further store therein instructions that cause the information processing apparatus to perform operations further comprising controlling the non-player character such that the reference direction is shifted to a direction from the non-player character to a player character.

According to the configuration of the above (10), the object can be moved to face the front as viewed from the player character.

(11)

The storage medium may further store therein instructions that cause the information processing apparatus to perform operations further comprising deleting a part of the composite object according to a motion of a player character.

According to the configuration of the above (11), the player can change the shape of the object by operating the player character.

(12)

The storage medium may further store therein instructions that cause the information processing apparatus to perform operations further comprising, when the part of the composite object has been deleted, restoring the shape of the composite object to an original shape thereof according to a lapse of time.

According to the configuration of the above (12), the player can enjoy the game while repeatedly changing the shape of the object.

(13)

The second part may be an object representing an eye of the non-player character.

According to the configuration of the above (13), it is possible to reduce a risk that an object whose eye is placed unnaturally is generated.

(14)

The composite object may further include an object that represents a foot of the non-player character.

Note that the present specification discloses examples of an information processing apparatus and an information processing system that execute the processes in the above (1) to (14). Further, the present specification discloses an example of an information processing method that executes the processes in the above (1) to (14).

According to the storage medium, the information processing system, the information processing apparatus, or the information processing method described above, a variety of objects can be generated by using a plurality of parts.

These and other features, aspects and advantages of the subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a diagram showing an example of content of voxel data and content of material information;

FIG. 12 is a diagram showing an example of property information representing properties of materials;

FIG. 13 is a diagram showing an example of texture information representing textures of materials;

FIG. 14 is a diagram showing a method for generating a mesh;

FIG. 15 is a view showing an example of a game image including a terrain object;

FIG. 16 is a diagram showing an example of an outline of a process of generating a non-player character;

FIG. 17 is a diagram showing examples of generated body objects;

FIG. 18 is a diagram showing an example of three parts;

FIG. 19 is a diagram showing an example of parts placed based on parameters;

FIG. 20 is a diagram showing an example of a body object generated based on the parts shown in FIG. 19;

FIG. 21 is a diagram showing an example of a generated non-player character;

FIG. 22 is a diagram showing an example of various data used for information processing in a non-limiting game system;

FIG. 23 is a flowchart showing an example of a flow of game processing executed by the non-limiting game system; and

FIG. 24 is a sub-flowchart showing an example of a specific flow of a character generation process in step S4 shown in FIG. 23.

### DETAILED DESCRIPTION OF NON-LIMITING EXAMPLE EMBODIMENTS

### [1. Configuration of Game System]

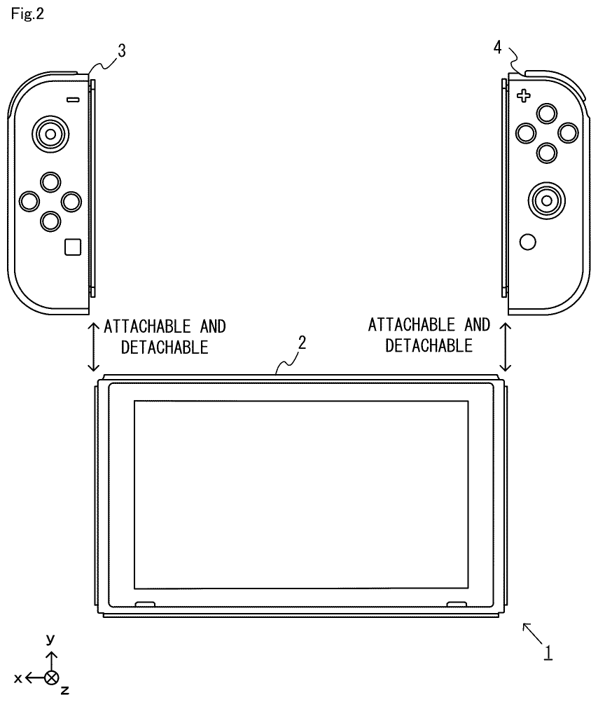

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

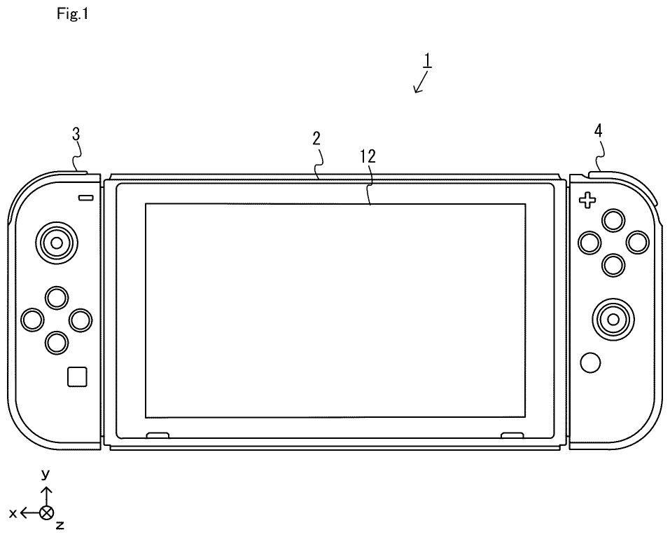

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

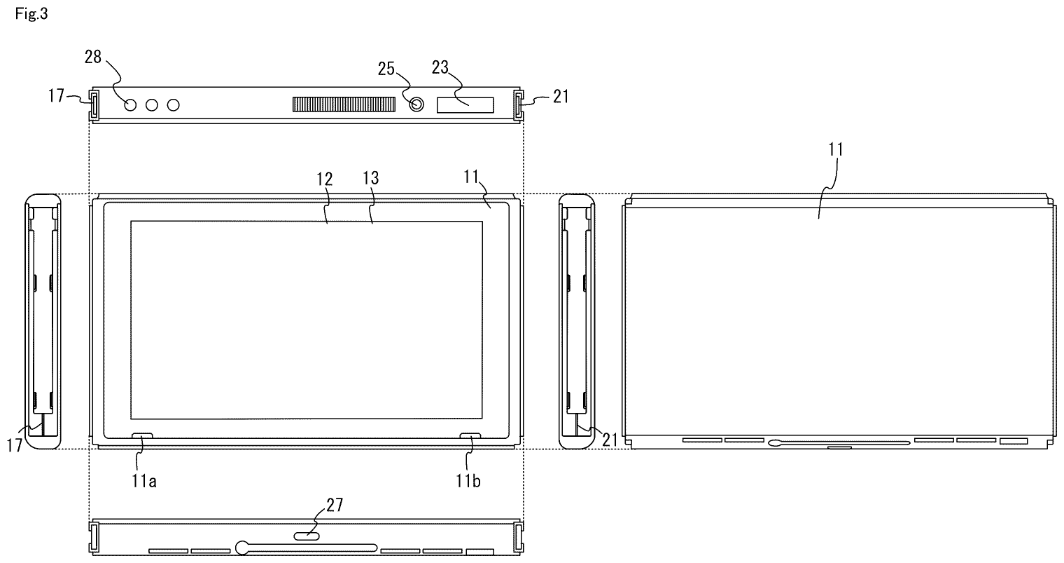

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

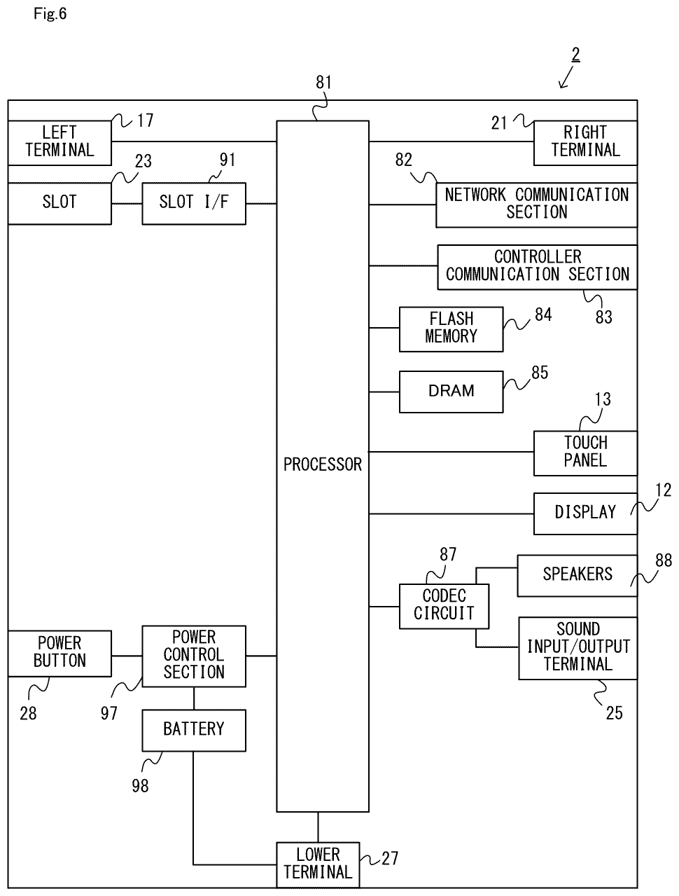

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

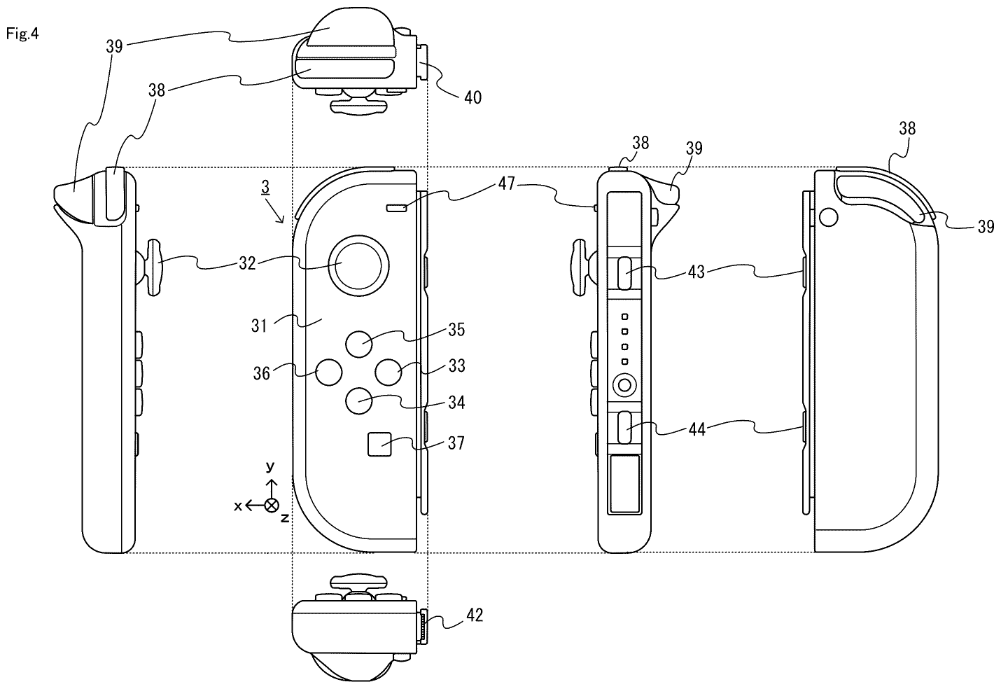

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

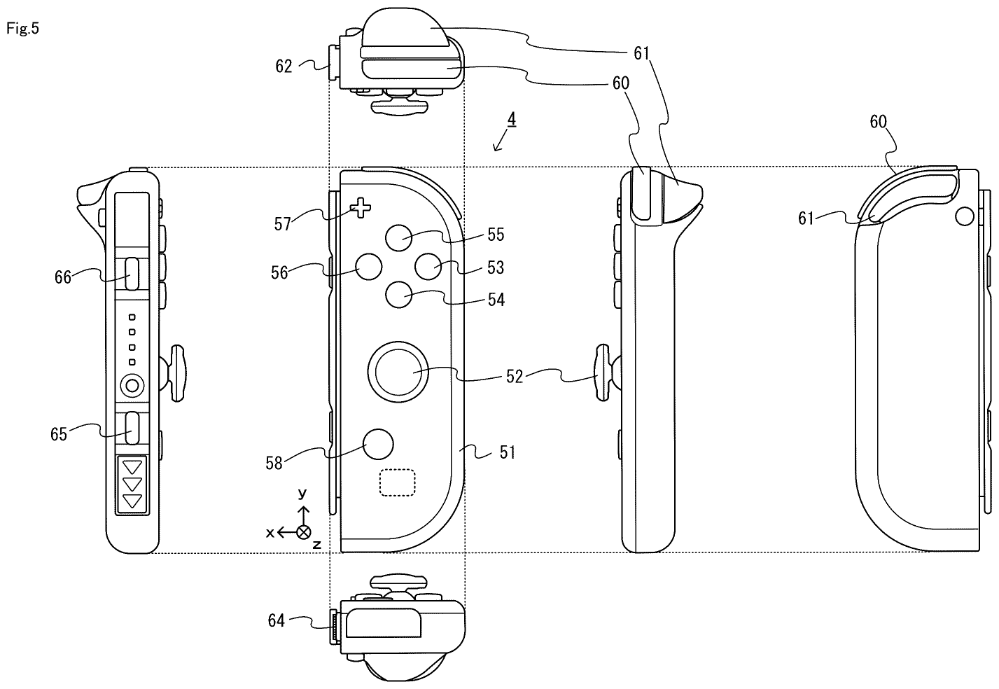

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external non-transitory storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable storage media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

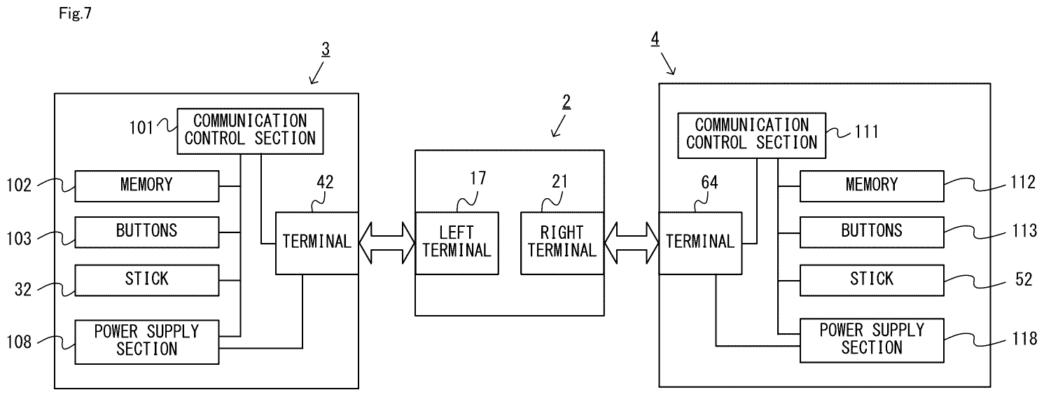

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

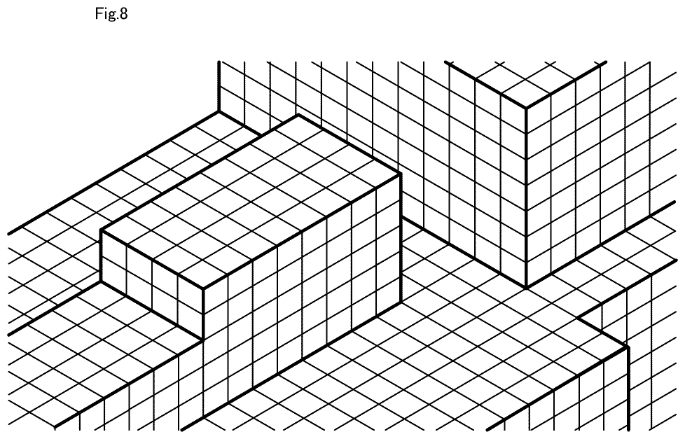

Next, referring to FIG. 8 to FIG. 21, an outline of the process performed on the game system 1 will be described. In the exemplary embodiment, the game system 1 generates a game image in which terrain objects and characters (e.g., the player character controlled by the player) are arranged in a game space, which is a three-dimensional virtual space, and displays the game image on a display device. Note that in the exemplary embodiment, the display device on which the game image is displayed may be the display 12 described above, or may be a stationary monitor.

### [2-1. Voxel]

In the exemplary embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the exemplary embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the exemplary embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

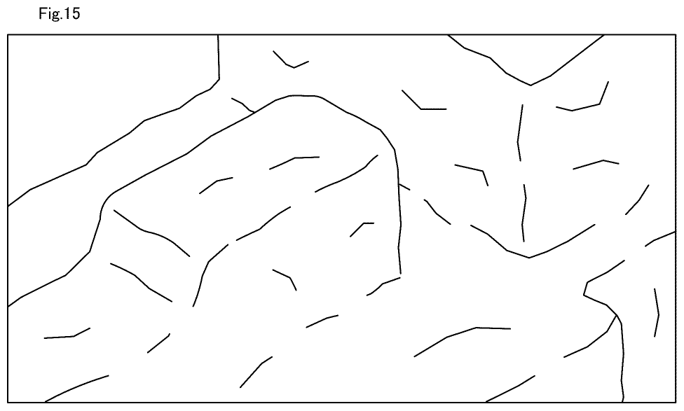

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the exemplary embodiment, in practice, a voxel object is generated (e.g., based on voxel data) by such a rule that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

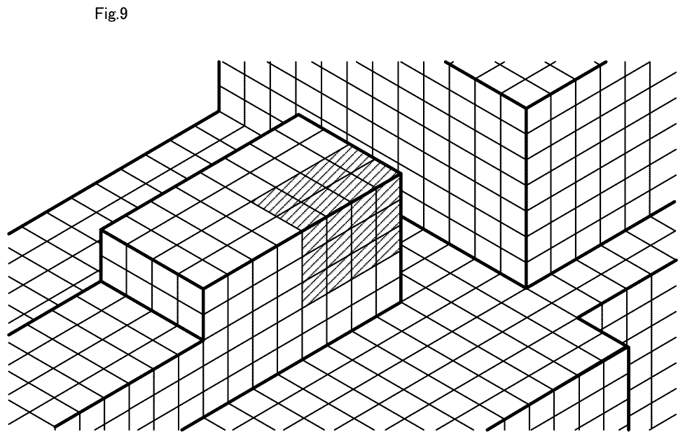

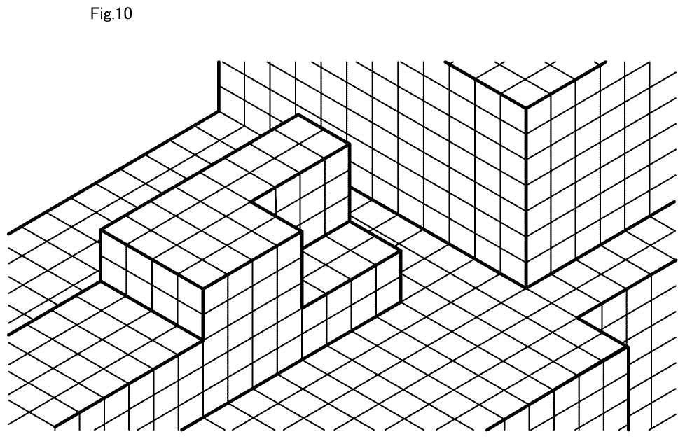

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

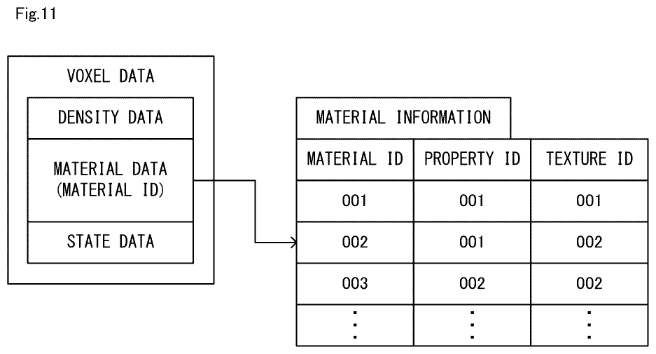

FIG. 11 is a diagram showing an example of content of voxel data. Here, in the exemplary embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the exemplary embodiment, this density is used to generate a mesh that defines the surface of the voxel object.

In the exemplary embodiment, the density can take an integer value in the range from the lower limit value (e.g., 0) to the upper limit value (e.g., 255). In the exemplary embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 11, voxel data includes material data. The material data represents the material (in other words, the substance) of the voxel object generated by the voxel data. Here, in the exemplary embodiment, materials such as sand, rock and soil, for example, are set for voxel objects. That is, in the exemplary embodiment, a plurality of types of materials are provided as materials that can be set for a voxel object, and one of the materials is set for a voxel object.

As shown in FIG. 11, in the exemplary embodiment, the material data represents the identification information of the material (referred to as “material ID”). In the exemplary embodiment, the game system 1 stores material information representing the property and the texture of the material for each material provided in the game. In the exemplary embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

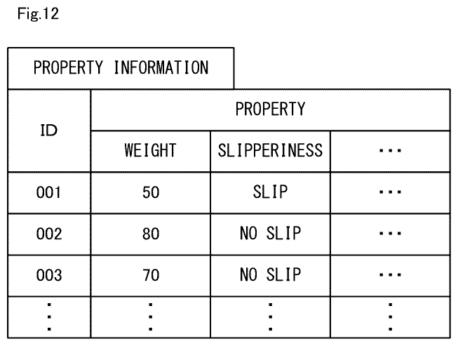

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object
Note that there is no limitation on the specific content of the property to be set for a material. In other embodiments, information different from those listed above may be set as information that represents a property of a material.

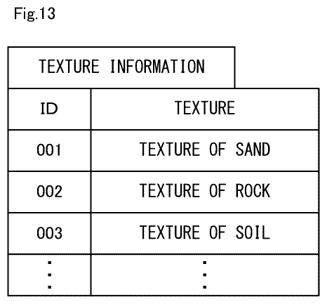

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the exemplary embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the exemplary embodiment, the game system 1 separately manages the property and the texture of the material. Therefore, in the exemplary embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the exemplary embodiment, the surface of the voxel object is represented by a mesh. A mesh is a set of faces (specifically, polygons) placed in the game space. In the exemplary embodiment, the game system 1 generates a mesh for the voxel object based on the voxel data of each voxel set in the game space. An example of how a mesh is generated based on voxel data will now be described.

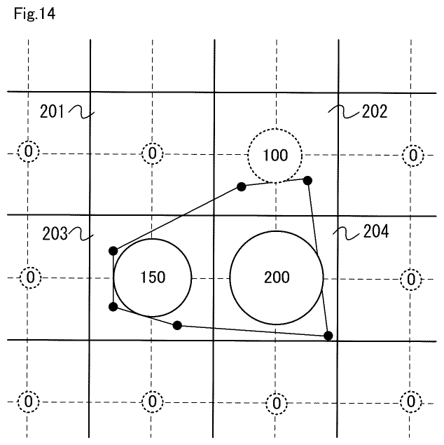

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the exemplary embodiment, the density set for a voxel is in the range of 0 to 255. In the exemplary embodiment, voxels with densities equal to or greater than the reference threshold value are considered to be inside the voxel object, and voxels with densities less than the reference threshold value are considered to be outside the voxel object. It is not necessary to define only voxels with a density of 0 as being outside the voxel object (e.g., reference threshold value=1), and the reference threshold value may be set to 128, for example. In the example shown in FIG. 14, a voxel 201 and the other outer voxels have a density of 0, a voxel 202 has a density of 100, which is less than the reference threshold value, and voxels 203 and 204 have densities of 150 and 200, which are greater than the reference threshold value (e.g., 128). In the exemplary embodiment, the game system 1 generates vertices between those voxels whose densities are equal to or greater than the reference threshold value and those voxels whose densities are less than the reference threshold value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference threshold value and a voxel whose density is less than the reference threshold value. Then, a polygon mesh is generated by connecting together adjacent vertices if the connection (the boundary between the regions including the vertices) passes through a voxel whose density is equal to or greater than the reference threshold value and a voxel whose density is less than the reference threshold value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference threshold value, the voxel 202 is treated as being outside the voxel object in the determination of the presence/absence of a vertex, but the density value itself of the voxel 202 is used to calculate the coordinates of the vertices generated. If the reference threshold value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference threshold value are treated as being outside the voxel object in the exemplary embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the exemplary embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### [2-3. Generation of Voxel Object]

A method of generating, as a voxel object, a non-player character that appears in a game space will be described below. In the exemplary embodiment, the game system 1 generates a non-player character such that the shape of the non-player character varies each time it is generated. Further, by generating a plurality of non-player characters such that the shapes thereof vary each time they are generated, it is possible to make the player have an impression that the respective non-player characters are not uniform but have individualities. As will be described in detail below, in the exemplary embodiment, the game system 1 automatically (specifically, by a procedural technique) generates a non-player character at an appropriate timing during the game.

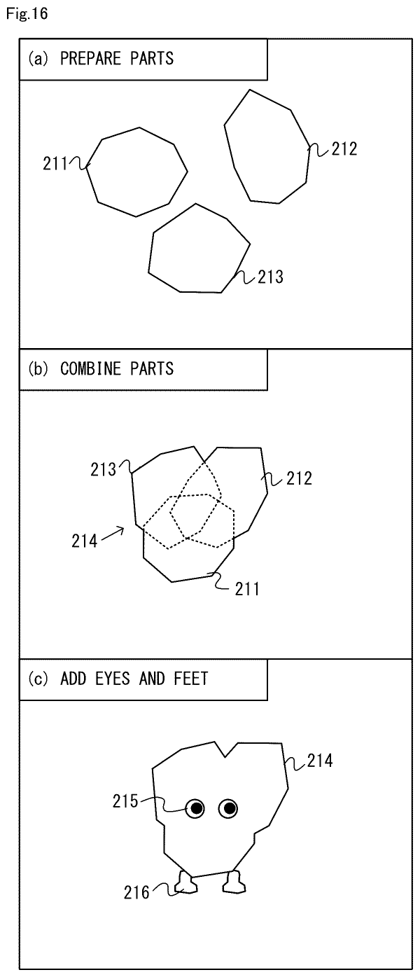

FIG. 16 is a diagram showing an example of an outline of a process of generating a non-player character. As shown in FIG. 16, a non-player character according to the exemplary embodiment is a character having a body that looks like a rock, eyes, and feet. In the exemplary embodiment, a plurality of parts for generating the body of the non-player character are prepared. As shown in (a) of FIG. 16, in the exemplary embodiment, three parts 211 to 213 are prepared. Note that the number of parts to be prepared may be any number not less than two.

As shown in (b) of FIG. 16, the game system 1 generates an object 214 that represents the body of the non-player character (referred to as “body object”) by combining the plurality of parts 211 to 213. At this time, the game system 1 determines, at random, positions and attitudes (or inclinations) of the three parts 211 to 213, and generates one body object 214 by combining the three parts 211 to 213. Therefore, the body object 214 can have a variety of shapes. That is, in the exemplary embodiment, a body object 214 having a different shape is generated for each generation process.

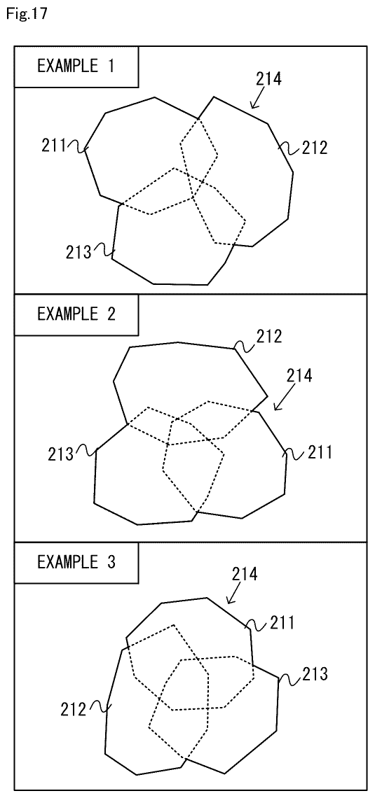

FIG. 17 is a diagram showing examples of body objects that can be generated. In the exemplary embodiment, by generating body objects 214 by combining the plurality of parts 211 to 213 at random, it is possible to generate a plurality of non-player characters having different shapes such as Examples 1 to 3 shown in FIG. 17.

As shown in (c) of FIG. 16, the game system 1 adds eye objects 215 and foot objects 216 to the generated body object 214. Thus, the non-player character is completed. Note that in the exemplary embodiment, the eye objects 215 and the foot objects 216 are placed at predetermined positions.

In the exemplary embodiment, the parts 211 to 213 and the body object 214 are voxel objects. Note that in the exemplary embodiment, the shapes of the parts 211 to 213 and the body object 214, which are the voxel objects included in the non-player character, are defined by voxel data regarding voxels different from those of the terrain object described above. That is, a voxel space regarding the non-player character (referred to as “sub-voxel space”) is a voxel space that is set separately from a voxel space regarding the terrain object (referred to as “main-voxel space”). The sub-voxel space is set in a part of the game space (or a part of the main-voxel space), and the non-player character is placed in the sub-voxel space. The size and the orientation of each voxel (e.g., the orientation of each side of the voxel) in the sub-voxel space may be different from the size and the orientation of each voxel in the main-voxel space. For example, by setting a sub-voxel space that defines a voxel of which each side has a length shorter than that of a voxel in the main-voxel space, it is possible to represent the shape of the non-player character more minutely than the terrain object based on the main-voxel space. Further, the game system 1 changes the position or the attitude of the sub-voxel space in the game space, thereby changing the position or the attitude of the non-player character (more precisely, the position or the attitude in the game space). When generating a plurality of non-player characters, the game system 1 sets a sub-voxel space for each non-player character.

Note that in other embodiments, in addition to the body object 214, the eye objects 215 and the foot objects 216 may also be voxel objects (e.g., the entirety of the non-player character may be a voxel object). In other embodiments, the shape of the non-player character may be defined by the voxel data of the main-voxel space described above. In other embodiments, the non-player character may not necessarily be a voxel object.

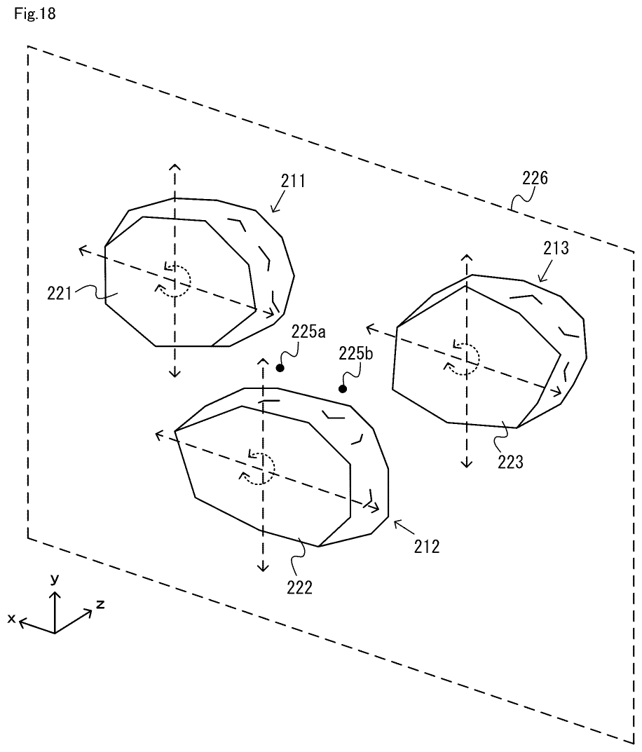

Next, referring to FIG. 18 to FIG. 21, the process of generating a non-player character will be described in detail. FIG. 18 is a diagram showing examples of the three parts. As described above, in the exemplary embodiment, the non-player character has an appearance like a rock. Therefore, each of the parts 211 to 213 is an object imitating a rock as shown in FIG. 18.

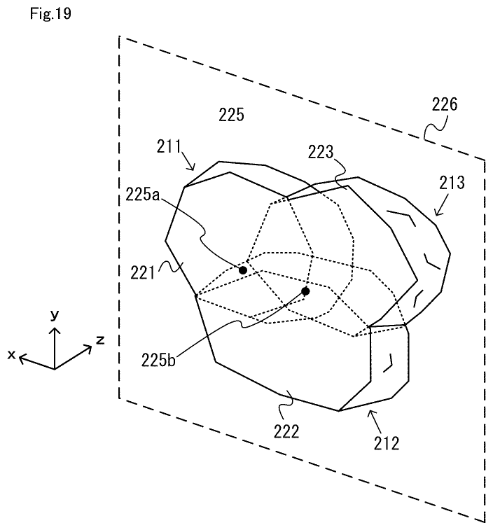

Note that FIG. 18 and FIG. 19 show the parts 211 to 213 on which meshes are generated, for the purpose of making the conception of the generation process easier to understand. In the exemplary embodiment, however, the parts 211 to 213 are provided with voxel data, and the game system 1 may not necessarily generate meshes for the parts 211 to 213.

The parts 211 to 213 are placed in the sub-voxel space regarding the non-player character. An x-axis direction of a coordinate system (xyz coordinate system shown in FIG. 18) of the sub-voxel space is the horizontal direction, and is a direction (a left-right direction) perpendicular to a front-rear direction described later. When the sub-voxel space (in other words, the non-player character) is placed in a reference attitude in the game space, the x-axis direction is parallel to the horizontal direction in the game space. A y-axis direction of the coordinate system is the vertical direction (or an up-down direction). When the sub-voxel space is placed in the reference attitude in the game space, the y-axis direction corresponds to the vertical direction in the game space. A z-axis direction of the coordinate system corresponds to a front-rear direction of the non-player character. Specifically, a z-axis positive direction side is the back side of the non-player character while a z-axis negative direction side is the front side of the non-player character. In the exemplary embodiment, generation of a non-player character is performed in the sub-voxel space, and the non-player character is placed in the game space by setting the sub-voxel space in the game space.

Note that in FIG. 18, the parts 211 to 213 are spaced apart from each other for the purpose of making the parts 211 to 213 easier to see. However, in actuality, the parts 211 to 213 are placed so as to partially overlap each other as shown in FIG. 19.

As shown in FIG. 18, in the exemplary embodiment, the parts 211 to 213 have flat surface portions 221 to 223, respectively. In the exemplary embodiment, the surface portions 221 to 223 are planes. However, the term “flat” does not strictly mean a plane. As will be described in detail below, after the body object 214 is generated based on the parts 211 to 213, the eye objects 215 are placed on a surface formed by the surface portions 221 to 223. In this case, the flat surface portions 221 to 223 may have small irregularities as long as the irregularities do not cause an inconvenience that a part or the entirety of an eye object 215 placed on the surface is hidden behind the body object 214 and becomes invisible.

In the exemplary embodiment, for each of the parts 211 to 213, a position parameter indicating the position of the part, a rotation parameter indicating rotation (or attitude) of the part, and a scale parameter indicating the size of the part, are set. The position parameter is a parameter indicating position coordinates in the sub-voxel space, the rotation parameter is a parameter indicating a rotation angle with respect to a reference attitude in the sub-voxel space, and the scale parameter is a parameter indicating a ratio of the size to a reference (e.g., the size of the part when a reference size is 1) in the sub-voxel space. Note that the scale parameter may be a parameter that indicates the ratio for each axis.

In the exemplary embodiment, the game system 1 determines, at random, a set of the parameters described above (e.g., the position parameter, the rotation parameter, and the scale parameter) for each part. In this specification, “determining at random” includes not only a method in which determination results (e.g., sets of the parameters) are obtained with equal probability, but also any method in which the results of a plurality of times of determination are not the same (e.g., have randomness) by using random numbers, for example. For example, when generating a plurality of non-player characters, in order to prevent the non-player characters from having similar shapes, the game system 1 may determine the sets of the parameters at random such that the values of the parameters are not biased between the generated non-player characters.

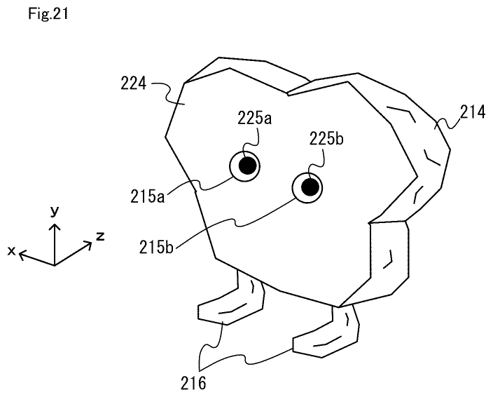

In the exemplary embodiment, the game system 1 determines the sets of the parameters at random such that the surface portions 221 to 223 are located within a reference plane 226 which includes reference positions 225a and 225b and is perpendicular to the front-rear direction, and the surface portions 221 to 223 face the front side (e.g., face in the z-axis negative direction). Here, the reference positions 225a and 225b are positions which are determined in advance in the sub-voxel space and at which the eye objects 215 are placed. Specifically, the eye object 215a corresponding to the right eye is placed at the reference position 225a, and the eye object 215b corresponding to the left eye is placed at the reference position 225b (see FIG. 21). In the exemplary embodiment, the reference positions 225a and 225b are set at the same position with respect to the front-rear direction (e.g., the z-coordinate values of the reference positions 225a and 225b are the same value).

As for the set of reference positions (reference positions 225a and 225b in the above example), the game system 1 determines one set when determining the parameters. The game system 1 may select one set from among a plurality of candidates prepared in advance, and thereafter, may determine the parameters in accordance with the selected set of reference positions. Thus, variations regarding the positions of the eye objects 215 can be increased, whereby variations of the appearance of the non-player character can be further increased. Note that there is no limitation on the method of selecting one set of reference positions from among a plurality of candidates. For example, the game system 1 may select one set at random or in accordance with a predetermined rule.

In the exemplary embodiment, a position parameter is determined at random so as to be variable with respect to the left-right direction (e.g., the x-axis direction) and the up-down direction (e.g., the y-axis direction) and be a fixed value with respect to the front-rear direction (e.g., the z-axis direction). Specifically, when the position indicated by the position parameter corresponds to a position on the surface portion of a part, this fixed value is set to a value equal to a coordinate value regarding the front-rear direction of the reference positions 225a and 225b (e.g., a z-axis coordinate value). Thus, each of the parts 211 to 213 can be changed with respect to the left-right direction and the up-down direction each time the corresponding position parameter is determined, but it is fixedly placed with respect to the front-rear direction (see dashed line arrows shown in FIG. 18).

For example, the game system 1 sets initial coordinates for a position parameter in advance, and determines at random amounts of change from the initial coordinates with respect to the left-right direction and the up-down direction, thereby determining a position parameter. Note that the initial coordinates may be set to different values for each of the parts 211 to 213. Further, when determining a position parameter at random, a range in which the position parameter can be changed from the initial coordinates may be set. For example, the game system 1 may change the position parameter from the initial coordinates within a range in which the surface portions 221 to 223 of the parts 211 to 213 include the reference positions 225a and 225b. Thus, the surface portions 221 to 223 can be prevented from being placed at positions that do not include the reference positions 225a and 225b (although the positions are within the reference plane 226).

A rotation parameter is determined at random so as to be variable with respect to an angle around an axis in the front-rear direction and be a fixed value with respect to an angle around an axis in the left-right direction and an axis in the up-down direction. Specifically, this fixed value is set such that the surface portions 221 to 223 are perpendicular to the front-rear direction and face the front side. Thus, each of the parts 211 to 213 can be changed with respect to the angle around the axis in the front-rear direction each time the corresponding rotation parameter is determined, but it is placed at a fixed angle around the axis in the left-right direction and the axis in the up-down direction (see dotted line arrows shown in FIG. 18).

For example, the game system 1 sets an initial angle for a rotation parameter in advance, and determines at random an amount of change from the initial angle with respect to the angle around the axis in the front-rear direction, thereby determining a rotation parameter. Note that the initial angle may be set to different values for each of the parts 211 to 213.

In the exemplary embodiment, a scale parameter is set to a predetermined fixed value. In other embodiments, however, the game system 1 may determine a scale parameter at random so as to be changeable. In this case, the game system 1 may change the scale parameter while adjusting the other parameters such that the direction in which the surface portions 221 to 223 face (e.g., the front direction) and the positions of the surface portions 221 to 223 with respect to the front-rear direction are not changed. For example, the scale parameter being changed may cause the positions of the surface portions of the parts to be changed in the front-rear direction. Therefore, the game system 1 changes the position parameter so as to offset the change in the positions of the surface portions due to the change in the scale parameter, thereby consequently preventing the positions of the surface portions from being changed with respect to the front-rear direction. Note that with respect to the left-right direction and the up-down direction, the position parameter need not be adjusted even when the scale parameter is changed as described above, and therefore, it can be said that the position parameter can be easily changed with respect to the left-right direction and the up-down direction.

As described above, in the exemplary embodiment, the game system 1 determines at least one of the above parameters, based on probability (e.g., by using random numbers). Thus, non-player characters having a variety of shapes can be generated. Note that among the parameters described above, one parameter, or two or more parameters may be determined based on probability so as to have randomness.

FIG. 19 is a diagram showing examples of the parts that are placed based on the parameters determined as described above. The parts 211 to 213 are placed so as to include the reference positions 225a and 225b, and therefore are placed so as to partially overlap with at least one of the other parts as shown in FIG. 19. In other embodiments, however, the parts 211 to 213 may be placed so as not to overlap with the other parts. Further, since the direction in which the surface portions 221 to 223 face and the positions of the surface portions 221 to 223 with respect to the front-rear direction are fixedly set as described above, the surface portions 221 to 223 are arranged to be located within the reference plane 226 including the reference positions 225a and 225b.

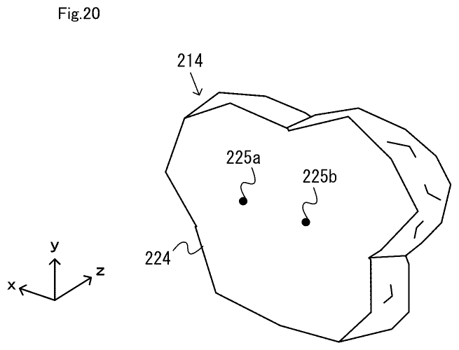

After the parts 211 to 213 have been arranged, the game system 1 generates a body object 214 by combining the parts 211 to 213. FIG. 20 is a diagram showing an example of the body object generated based on the parts 211 to 213 shown in FIG. 19. As shown in FIG. 20, the game system 1 generates the body object 214 such that the body object 214 has a shape obtained by integrating the parts 211 to 213 (specifically, such that the surface of the body object 214 is formed by the surfaces of portions, of the parts 211 to 213, which do not overlap with the other parts). The body object 214 has a surface portion 224 which corresponds to the surface formed by the surface portions 221 to 223 of the parts 211 to 213 and is located so as to include the reference positions 225a and 225b.

As described above, in the exemplary embodiment, the plurality of parts 211 to 213 and the body object 214 of the player character are voxel objects generated based on voxel data. Therefore, for example, the game system 1 can obtain voxel data of the body object 214 by adding, for each voxel, the densities in the voxel data of the parts 211 to 213. Thus, in the exemplary embodiment, the process of obtaining the body object 214 by combining the parts 211 to 213 can be easily performed by using the voxel data. Further, when generating the body object 214 by using the voxel data, since the number of vertices of a mesh for the generated body object 214 can be varied for each generation process, body objects having a wide variety of shapes can be easily generated. Note that in other embodiments, the parts 211 to 213 and the body object 214 may not necessarily be voxel objects, and the player character may not necessarily be a voxel object.

Note that there is no limitation on the specific method of generating the body object 214 by combining the parts 211 to 213. For example, the game system 1 may generate a body object constituted by a mesh by combining parts each being constituted by a mesh. Further, the shape defined by the parts 211 to 213 need not exactly coincide with the shape of the body object 214. Specifically, the surfaces of the portions, of the parts 211 to 213, which do not overlap with the other parts need not exactly coincide with the surface of the body object 214. For example, the game system 1 may generate a body object by changing the shape of a boundary area between a certain part and another part so as to smooth corners.

Note that in the exemplary embodiment, the same material (specifically, property and texture) is set for the parts 211 to 213. However, in other embodiments, there is no limitation on the materials set for the parts 211 to 213, and different materials may be set for the respective parts. In this case, as for the body object 214, different materials may be set for the portions corresponding to the original parts, a material based on the materials of the respective parts (e.g., a material obtained by compositing the materials of the respective parts) may be set, or the material of any one of the parts may be set.

FIG. 21 is a diagram showing an example of a generated non-player character. As shown in FIG. 21, the game system 1 adds the eye objects 215 to the generated body object 214. In the exemplary embodiment, out of the two eye objects, the right eye object 215a is placed at the reference position 225a and the left eye object 215b is placed at the reference position 225b. As described above, the surface portion 224 of the body object 214 is placed at a position including the reference positions 225a and 225b. Therefore, as shown in FIG. 21, the eye objects 215 are placed on the surface of the surface portion 224.

Note that a reference position is a position in which any portion of an object (here, an eye object 215) to be placed at the reference position is placed, and therefore, the reference position is not limited to the center position of the object. That is, the eye object 215 may be placed such that a portion thereof is located at the reference position, and therefore, the other portion of the eye object 215 may be embedded in the body object 214.

As described above, in the exemplary embodiment, the game system 1 determines the parameters (e.g., the position parameter, the rotation parameter, and the scale parameter) such that the reference positions 225a and 225b are located at the surface of the non-player character. Thus, it is possible to reduce a risk that the non-player character looks unnatural because an eye object 215 is embedded in the body object 214 and becomes invisible or an eye object 215 is placed apart from the body object 214. Note that in other embodiments, the above parameters may be determined to have values such that the reference positions are placed apart from the surface of the non-player character (e.g., such that the reference positions are placed a little apart in the forward direction from the surface of the non-player character).

As described above, in the exemplary embodiment, in the three-dimensional virtual space, the plurality of parts 211 to 213 have the flat surface portions 221 to 223, respectively. The game system 1 determines the position parameter and the scale parameter such that the plane including the reference positions 225a and 225b (the reference plane 226 in the exemplary embodiment) and the surface portions 221 to 223 of the plurality of parts 211 to 213 are located within the same plane. Further, the game system 1 determines the rotation parameter such that the surface portions 221 to 223 are perpendicular to a reference direction (the z-axis negative direction in the exemplary embodiment) and face in the reference direction. Thus, the eye objects 215 can be placed on a surface formed based on the surface portions of the parts 211 to 213 (e.g., on the surface portion 224 of the body object 214), thereby reducing the risk that the non-player character looks unnatural. Note that in other embodiments, a part may have a plurality of flat surface portions. In this case, the game system 1 may determine a rotation parameter for this part such that any one of the plurality of flat surface portions is perpendicular to the reference direction and faces in the reference direction.

As described above, in the exemplary embodiment, the game system 1 determines, for each of the plurality of parts 211 to 213, each parameter within a predetermined range such that the reference position is not shielded by the body object on the side in the reference direction of the non-player character. Specifically, the position parameter is determined within a range in which the surface portion of the part includes the reference position, and the rotation parameter is determined to be a fixed value with respect to the axis in the left-right direction and the axis in the up-down direction. This reduces the risk that the non-player character looks unnatural. Note that in other embodiments, the specific content of the “predetermined range” is not limited to that of the above embodiment, and other ranges may be adopted. For example, in other embodiments, the game system 1 may set a possible value of the rotation parameter in a range that is variable with respect to the axis in the left-right direction or the axis in the up-down direction, and may adjust, according to the value of the rotation parameter in this range, the ranges of the other parameters (e.g., the position parameter and the scale parameter) such that the reference position is not shielded by the body object.

Moreover, the game system 1 adds the foot objects 216 to the body object 214. In the exemplary embodiment, the foot objects 216 are placed at predetermined positions. Note that in the exemplary embodiment, generation of the body object 214 is not limited with respect to the positions of the foot objects 216, unlike the eye objects 215. Therefore, there is a case where a part of a foot object 216 is embedded in the body object 214 or a foot object 216 is placed apart from the body object 214. Note that in the exemplary embodiment, the most part of the non-player character 211 is a body (or a face) of the non-player character 211, and therefore, the positions of the eye objects 215 on the body object 214 are considered to have an influence on the unnaturalness in the appearance of the non-player character 211. In contrast, the foot objects 216 are considered to have less influence on the unnaturalness in the appearance of the non-player character (as compared to the eye objects 215) even in the above case. Therefore, in the exemplary embodiment, the foot objects 216 are fixedly placed regardless of the shape of the body object 214.

Note that in other embodiments, the game system 1 may place a foot object 216 so as not to be partially hidden by the body object 214. For example, if a foot object 216 will be partially embedded in the body object 214 or separated from the body object 214 when the foot object 216 is placed at a predetermined reference position, the game system 1 may move the foot object 216 in the up-down direction (e.g., the y-axis direction) from the reference position such that an upper end of at least one of the foot objects 216 comes into contact with the body object 214.

As described above, in the exemplary embodiment, the non-player character has the foot objects 216, but the non-player character may have any shape. For example, in other embodiments, the non-player character may not necessarily have the foot objects 216, and may have hand objects in addition to (or instead of) the foot objects 216.

The non-player character generated as described above is placed in the game space. In the exemplary embodiment, the game system 1 places the non-player character in the game space by placing the sub-voxel space of the non-player character in the game space.

In the exemplary embodiment, the process of generating a non-player character is executed when a generation condition has been satisfied during the game. In the exemplary embodiment, the generation condition is that a new game stage is generated during the game (e.g., according to movement of the player character to a new game stage, data of the new game stage as a destination is read into the DRAM 85). When the generation condition has been satisfied, the game system 1 executes a process of generating a non-player character that appears in the new stage. Note that there is no limitation on the generation condition to be satisfied during the game. For example, the generation condition may be that a timing to display a non-player character has come (e.g., a timing to render the non-player character has come with the distance from the virtual camera to the non-player character having reached a predetermined distance).

As described above, in the exemplary embodiment, the game system 1 determines the parameters (e.g., the position parameter, the rotation parameter, and the scale parameter) during execution of the game, and places the non-player character based on the determined parameters in the virtual space (e.g., the game space) during execution of the game. Thus, the game system 1 can generate a non-player character having a different shape each time the game system 1 executes the game. The phrase “during execution of the game” includes the time when the game is started. That is, the game system 1 may execute the generation process at the time when the game is started. In other embodiments, the generation process may be executed at a timing when the game is not executed.

The game system 1 controls the motion of the non-player character placed in the game space. In the exemplary embodiment, the game system 1 changes the direction of the non-player character according to the game state. Specifically, the game system 1 controls the non-player character such that the reference direction (e.g., the front direction) of the non-player character is shifted to a direction from the non-player character to the player character. Thus, the non-player character can be moved to face the front as viewed from the player character. Note that in other embodiments, the game system 1 may not necessarily control the motion of the non-player character, and the non-player character may be an object that does not move (e.g., an object simply placed in the game space).

In the exemplary embodiment, since the non-player character (specifically, the body object 214) is a voxel object, the non-player character can be deleted (or broken) during the game, like the terrain object described above. Specifically, when any impact has been applied to the non-player character, the game system 1 deletes a part of the body object 214 by updating the voxel data of the body object 214 (more specifically, the density data described above). For example, the game system 1 deletes a part of the non-player character, according to an action of the player character (e.g., an action of punching the non-player character, or an action of hitting the non-player character against another object). Thus, the player can change the shape of the non-player character by operating the player character. In the exemplary embodiment, since the non-player character can have a variety of shapes, the broken non-player character can have various shapes even if the breaking action by the player character is the same. Therefore, amusement in the operation of breaking the non-player character can be further improved.

When a part of the non-player character (specifically, the body object 214) has been deleted as described above, the game system 1 restores the shape of the non-player character to the original shape according to the lapse of time. Specifically, the game system 1 gradually changes the voxel data (more specifically, the density data) of the body object 214 according to the lapse of time so as to be restored to the value before update. Therefore, even when the non-player character has been broken by the action of the player character, the non-player character is gradually restored to its original shape. Thus, the player can enjoy the game while repeatedly changing the shape of the non-player character.

Note that another object may be added to the non-player character, like the terrain object described above. Specifically, in a case where a predetermined object (e.g., a rock object having the same material as the body object 214) comes into contact with the body object 214 of the non-player character, the game system 1 integrates this object with the body object 214. That is, in the above case, the game system 1 regards a shape obtained by adding the object to the original shape of the body object 214, as a new shape of the body object 214. Further, also when another object has been added to the non-player character, the game system 1 may restore the shape of the non-player character to its original shape according to the lapse of time, as in the case where a part of the non-player character has been deleted.

### [3. Specific Example of Processing in Game System]

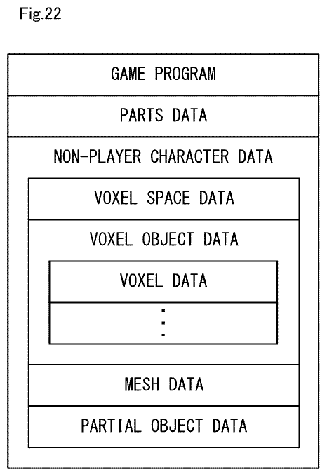

Next, referring to FIG. 22 to FIG. 24, a specific example of information processing in the game system 1 will be described.

FIG. 22 is a diagram showing an example of various data used for the information processing in the game system 1. As shown in FIG. 22, the game system 1 has, stored therein, a game program, parts data, and non-player character data. The game program and the parts data are data that are stored in the game system 1 in advance of execution of game processing. The game program and the parts data are stored in the storage medium attached to the slot 23 of the main body apparatus 2, for example. The non-player character data is data that is generated during execution of the game processing. The non-player character data is stored in the DRAM 85 in the main body apparatus 2, for example.

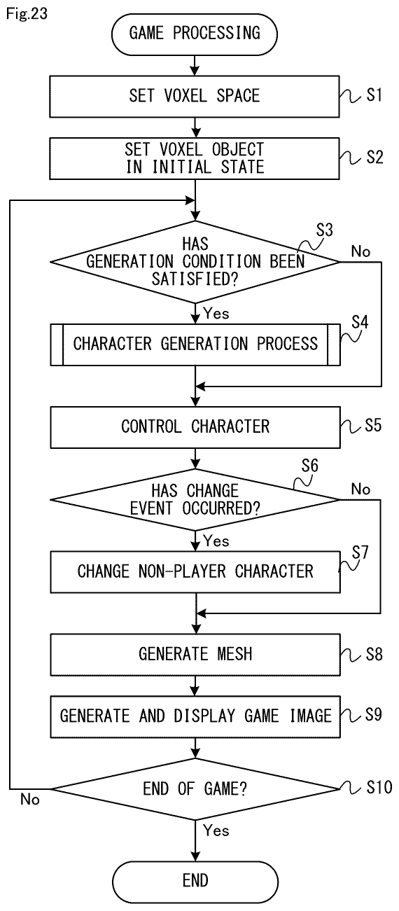

The game program is a game program for executing the game processing of the exemplary embodiment (specifically, game processing shown in FIG. 23).

The parts data is data regarding the parts 211 to 213 described above. Specifically, the parts data includes data that represents the shapes of the parts 211 to 213.

The non-player character data is data regarding a non-player character. The non-player character data includes voxel space data, voxel object data, mesh data, and partial object data. In the exemplary embodiment, the non-player character data is generated and stored for each non-player character. Note that the non-player character data may include data that represents the posture and the state of the non-player character.

The voxel space data that defines a sub-voxel space regarding the non-player character. Specifically, the voxel space data includes data that represents the length of each side of a voxel in the sub-voxel space. Further, the voxel space data includes data that represents the position, the attitude, and the size of the sub-voxel space in the game space.

The voxel object data includes voxel data regarding the non-player character, that is, voxel data for each voxel in the sub-voxel space. The voxel object data is data that defines the shape of the non-player character in the sub-voxel space.

The mesh data is data that represents a mesh set for the non-player character. The mesh data includes data representing the positions of vertexes in the mesh, for example.

The partial object data is data regarding a partial object (the eye objects and the foot objects in the exemplary embodiment) that is a part, of the non-player character, other than the voxel object. Specifically, the partial object data includes data representing the shape, the position, and the attitude of the partial object.

Further, the game system 1 has, stored therein, data that defines a main-voxel space set in the game space, data that represents a voxel object (here, the terrain object) placed in the main-voxel space, a mesh that is set for the voxel object (e.g., the mesh for the terrain object), and the like, in addition to the data shown in FIG. 22.

FIG. 23 is a flowchart showing an example of a flow of game processing executed by the game system 1. For example, the game processing shown in FIG. 23 is started when an instruction to start the game has been made by the player during execution of the game program.

In the exemplary embodiment, the processor 81 of the main body apparatus 2 executes the game program stored in the game system 1 to execute processes in steps shown in FIG. 23. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 23 may be executed by the another information processing apparatus. The processes in the steps shown in FIG. 23 are merely examples, and the processing order of the steps may be changed or another process may be executed in addition to (or instead of) the processes in the steps as long as similar results can be obtained.

The processor 81 executes the processes in the steps shown in FIG. 23 by using a memory (e.g., the DRAM 85). That is, the processor 81 stores information (in other words, data) obtained in each process step, into the memory, and reads out the information from the memory when using the information for the subsequent process steps.

In step S1 shown in FIG. 23, the processor 81 sets a voxel space in a game space. Specifically, the processor 81 acquires the voxel space data described above, and stores (in other words, writes) the data into the DRAM 85. In the subsequent game processing, the processor 81 may sometimes refer to the voxel space data when executing a process regarding a voxel object (e.g., the process in step S2). In this case, the processor 81 refers to the voxel space data stored in the DRAM 85. Next to step S1, the process in step S2 is executed.

In step S2, the processor 81 sets, in the game space, a voxel object (specifically, a terrain object) in a main-voxel space. Specifically, the processor 81 acquires voxel data that represents arrangement of the terrain object in the initial state, and stores (in other words, writes) a part or the entirety of the acquired voxel data into the DRAM 85. Note that the voxel data representing the arrangement of the terrain object in the initial state is stored in the storage medium attached to the slot 23 of the main body apparatus 2, for example. Next to step S2, the process in step S3 is executed.

In step S3, the processor 81 determines whether or not the above-described generation condition for generating a non-player character has been satisfied. For example, when the game has been started or when the player character has entered a new game stage, the processor 81 determines that the generation condition has been satisfied. When the determination result in step S3 is positive, the process in step S4 is executed. When the determination result in step S3 is negative, the process in step S4 is skipped and the process in step S5 is executed.

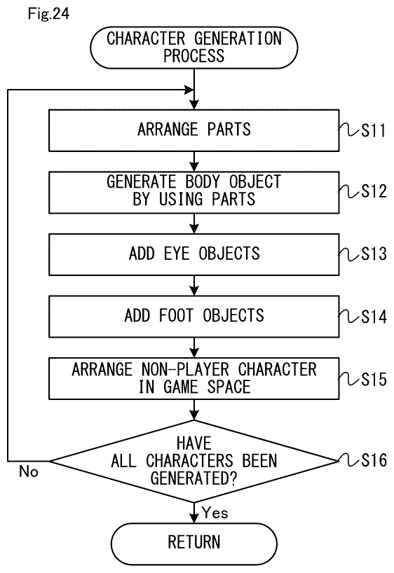

In step S4, the processor 81 executes a character generation process for generating a non-player character. Hereinafter, a specific flow of the character generation process will be described with reference to FIG. 24.

FIG. 24 is a sub-flowchart showing an example of the specific flow of the character generation process in step S4 shown in FIG. 23. In the character generation process, first, in step S11, the processor 81 places, in a sub-voxel space, a plurality of parts to be used for generating a non-player character (see FIG. 19). Specifically, the processor 81 determines, at random, a set of parameters (e.g., a position parameter, a rotation parameter, and a scale parameter) according to the method described in the above “[2-3. Generation of voxel object]”. Further, the processor 81 reads out parts data stored in the DRAM 85, and calculates voxel data that represents each part placed in the sub-voxel space, based on the parts data and the determined parameters. Next to step S11, the process in step S12 is executed.

In step S12, the processor 81 generates a body object of a non-player character, based on the parts placed in the sub-voxel space (see FIG. 20). Specifically, the processor 81 calculates voxel data of the body object, based on the voxel data calculated in step S11, according to the method described in the above “[2-3. Generation of voxel object]”. The calculated voxel data is stored in the DRAM 85 as the voxel object data regarding the non-player character. Next to step S12, the process in step S13 is executed.

In step S13, the processor 81 adds eye objects to the body object generated in step S12. Specifically, the processor 81 places the eye objects at the reference positions described above. At this time, the partial object data stored in the DRAM 85 with respect to the non-player character is updated so as to include data regarding the added eye objects. Next to step S13, the process in step S14 is executed.

In step S14, the processor 81 adds foot objects to the body object generated in step S12. Specifically, the processor 81 places the foot objects at predetermined positions. At this time, the partial object data stored in the DRAM 85 with respect to the non-player character is updated so as to include data regarding the added foot objects. Next to step S14, the process in step S15 is executed.

In step S15, the processor 81 places, in the game space, the non-player character generated through the processes in steps S11 to S14. Specifically, the processor 81 places the non-player character in the game space by setting the sub-voxel space of the non-player character in the game space. At this time, the voxel space data stored in the DRAM 85 with respect to the non-player character is updated so as to include data that represents the position, the attitude, and the size of the sub-voxel space in the game space. Next to step S15, the process in step S16 is executed.

The position, the attitude, and the shape of the non-player character in the game space have thus been defined by the voxel space data and the voxel object data stored in the DRAM 85, through the processes in steps S11 to S15. Note that a mesh for the non-player character is generated based on the voxel object data, through the process in step S8 described later.

In step S16, the processor 81 determines whether or not all the non-player characters to be generated have been generated with respect to the generation condition that was determined as satisfied in step S3. For example, in the case where the generation condition is satisfied according to generation of a new game stage, the processor 81 determines whether or not all the non-player characters to be generated in this character generation process, among non-player characters that appear in the new game stage, have been generated. When the determination result in step S16 is negative, the process in step S11 is executed again. Thereafter, a series of processes in steps S11 to S16 is repeated until the processor 81 determines in step S16 that all the non-player characters have been generated. When the determination result in step S16 is positive, the processor 81 ends the character generation process shown in FIG. 24. Next to the character generation process in step S4, the process in step S5 is executed.

In step S5, the processor 81 controls the motions of the various characters (specifically, the player character and the non-player character described above) that appear in the game space. The processor 81 controls the motion of the player object, based on operation data received from the controller 3 or 4, for example. Further, the processor 81 controls the non-player character so as to face the player character. Next to step S5, the process in step S6 is executed.

In step S6, the processor 81 determines whether or not a change event has occurred with respect to the non-player character as a result of movements of the various characters according to the process in step S5. A change event is a game event that causes the non-player character to change (e.g., that partially deletes the non-player character, adds another object to the non-player character, or restores the non-player character to its original shape). For example, when any impact has been applied to the non-player character, the processor 81 determines that a change event has occurred with respect to the non-player character. When the determination result in step S6 is positive, the process in step S7 is executed. When the determination result in step S6 is negative, the process in step S7 is skipped and the process in step S8 is executed.

In step S7, the processor 81 changes the non-player character, in which a change event has occurred, according to the change event. That is, the processor 81 partially deletes the non-player character, adds another object to the non-player character, or restores the non-player character, which has been deformed due to the deletion or addition, to its original shape. In the exemplary embodiment, as for at least some of the voxel data regarding the non-player character in which the change event has occurred, the processor 81 changes the densities represented by the voxel data. Thus, the non-player character in which the change event has occurred is deformed. Further, the processor 81 updates the voxel object data stored in the DRAM 85 so as to represent the densities having been changed. Next to step S7, the process in step S8 is executed.

In steps S6 and S7, the processor 81 also determines whether or not a change event has occurred in a voxel object (e.g., a terrain object) other than the non-player character, in the same manner as that for the non-player character. When the determination result is that a change event has occurred in the other voxel object, the processor 81 may change the other voxel object.

In step S8, the processor 81 generates a mesh for a voxel object. The mesh for the voxel object is generated according to the method described in the above “[2-2. Mesh]”. Note that in step S8, the processor 81 need not generate again a mesh that has been generated in the process in previous step S8, and may generate again a mesh based on the voxel data of the non-player character newly generated in step S4 (e.g., the voxel object data shown in FIG. 22) and on the voxel data updated in step S7. By the process in step S8, the mesh for the voxel object can be dynamically changed during the game. Note that the processor 81 updates the mesh data stored in the DRAM 85 to the content indicating the newly generated mesh. Next to step S8, the process in step S9 is executed.

In step S9, the processor 81 generates a game image representing a game space, and causes the display device to display the game image. Specifically, the processor 81 generates a game image that represents a game space including the voxel object and the other object. Note that an image of the voxel object is generated according to the method described in the above “[2-2. Mesh]” by using the voxel object data and the mesh data stored in the DRAM 85. The processor 81 causes the display device to display the generated game image. Note that during the game, the process in step S9 is repeatedly executed once every predetermined time (e.g., 1 frame time). Next to step S9, the process in step S10 is executed.

In step S10, the processor 81 determines whether or not to end the game. For example, the processor 81 determines whether or not an instruction to end the game has been made by the user. When the determination result in step S10 is negative, the process in step S3 is executed again. Thereafter, a series of processes in steps S3 to S10 is repeated until the processor 81 determines to end the game in step S10. When the determination result in step S10 is positive, the processor 81 ends the game processing shown in FIG. 23.

### [4. Functions and Effects of Exemplary Embodiment, and Modifications]

As described above, in the exemplary embodiment, the information processing system (specifically, the game system 1) is configured to include the following means.
Parameter determination means that determines parameters of a position, a rotation, and a scale for each of a plurality of parts (specifically, the parts 211 to 213 shown in FIG. 16, etc.) (step S11).
Object generation means that generates a composite object (specifically, a non-player character) including a first part (specifically, the body object 214) and a second part (specifically, the eye objects 215), the first part having a shape obtained by combining the plurality of parts placed in a virtual space based on the parameters, the second part being placed at a reference position in the virtual space and being different from the first part (steps S12, S13).

The parameter determination means determines the parameters such that the reference position is not shielded by the first part on a side in a reference direction (specifically, the front direction) of the composite object.

According to the above configuration, since the first part is generated by using the parts for which the parameters are changed to various values, composite objects having a variety of shapes can be generated. Moreover, since the parameters are determined such that the reference position is not shielded by the first part, it is possible to reduce the risk that a composite object in an unnatural form in which, for example, the second part is hidden behind the first part, is generated.

Note that the phrase “the reference position is shielded by the first part” indicates that the reference position is located inside the first part, and does not indicate that the reference position is located at the surface of the first part. Further, the second part to be placed at the reference position need not be placed such that the entirety thereof is not shielded by the first part, and may be placed such that at least a part thereof is not shielded by the first part. For example, in a case where the first part has a box shape that has a bottom surface portion and side surface portions, and an upper side being opened, if the reference position is located on an inner surface of a side surface portion of the box, the reference position may be regarded as being shielded by the first part when the first part is viewed from the front direction (in this example, the front direction is the reference direction). Therefore, in the above case, the game system 1 sets the parameters such that the reference position is located on an outer surface of the side surface portion at the front side of the box-shaped first part.

In the exemplary embodiment, the game system 1 prevents the reference position from being shielded by the first part by determining the parameters under the predetermined limitations. However, the parameter determination method is not limited thereto. In other embodiments, for example, the game system 1 may repeat the process of determining the parameters based on probability, until the parameters are determined such that the reference position is not shielded by the first part on the side in the reference direction of the composite object. In this case, the same effects as in the exemplary embodiment can be achieved.

In the exemplary embodiment, the composite object is a non-player character that is not operated by the player. In other embodiments, the composite object may be any object that appears in the game. The composite object may be a player character, or an object that is placed in the game space and does not make an action. For example, the composite object may be a terrain object, a rock object, or a tree object.

In the exemplary embodiment, the object (e.g., the second part) placed at the reference position is the eye object representing an eye of the non-player character. In other embodiments, the object placed at the reference position is not limited thereto. The second part may be any object that represents a part of an object. The second part may be an object representing a nose, a mouth, a hand, or a foot of the character. When the composite object is an object representing a battery, the second part may be an object representing a barrel of a cannon. When the composite object is an object representing a clock, the second part may be an object representing a clock face.

In the exemplary embodiment, the case of generating a three-dimensional composite object has been described as one example. However, the generation process of the exemplary embodiment is also applicable to generation of a two-dimensional composite object. That is, when generating a first part by using two-dimensional parts, the game system 1 may determine parameters of each part such that a reference position is not located inside the first part on a side in a reference direction of a two-dimensional plane.

In other embodiments, the game system 1 may change the shape of the composite object during the game. For example, the game system 1 may change the shape of the composite object to the rhythm, or may change the shape of the composite object according to change in the game state. In this case, the shape of the composite object after the change is determined in the same manner as that for generating the shape of the composite object in the generation process described above. Thus, the shape of the composite object can be changed at random.

In the exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the another information processing apparatus and the data stored therein.

In other embodiments, the information processing system may not include some of the components in the above embodiment, and may not execute some of the processes executed in the above embodiment. For example, in order to achieve a specific effect of a part of the above embodiment, the information processing system includes a configuration for achieving the effect and executes a process for achieving the effect, and need not include other configurations and need not execute other processes.

The exemplary embodiment can be used as, for example, a game system and a game program, in order to generate a variety of objects by using a plurality of parts.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing comprising:
determining parameters of a position, a rotation, and a scale for each of a plurality of parts; and
generating a composite object including a first part and a second part, the first part having a shape obtained by combining the plurality of parts placed in a virtual space based on the parameters, the second part being placed at a reference position in the virtual space and being different from the first part, wherein
the parameters are determined such that the reference position is not shielded by the first part on a side in a reference direction of the composite object.

2. The non-transitory computer-readable storage medium according to claim 1, wherein
the parameters are determined such that the reference position is located at a surface of the first part.

3. The non-transitory computer-readable storage medium according to claim 1, wherein
the virtual space is a three-dimensional space,
each of the plurality parts has a flat surface portion, and
the parameter of the position and the parameter of the scale are determined such that a flat surface including the reference position and the surface portions of the plurality of parts are located within the same plane, and the parameter of the rotation is determined such that the surface portions are perpendicular to the reference direction and face the side in the reference direction.

4. The non-transitory computer-readable storage medium according to claim 1, wherein
for each of the plurality of parts, the parameters are determined within a range that is set in advance such that the reference position is not shielded by the first part on the side in the reference direction of the composite object.

5. The non-transitory computer-readable storage medium according to claim 1, wherein
at least one of the parameters is determined based on probability.

6. The non-transitory computer-readable storage medium according to claim 1, wherein
a process of determining the parameters based on probability is repeatedly executed until the parameters are determined such that the reference position is not shielded by the first part on the side in the reference direction of the composite object.

7. The non-transitory computer-readable storage medium according to claim 1, wherein
the parameters are determined during execution of a game, and
the composite object is placed in the virtual space during execution of the game.

8. The non-transitory computer-readable storage medium according to claim 1, wherein
the plurality of parts, and the first part of the composite object are voxel objects generated based on voxel data.

9. The non-transitory computer-readable storage medium according to claim 1, wherein
the composite object is a non-player character.

10. The non-transitory computer-readable storage medium according to claim 9, wherein the information processing further comprises controlling the non-player character such that the reference direction is shifted to a direction from the non-player character to a player character.

11. The non-transitory computer-readable storage medium according to claim 9, having stored therein instructions that cause the information processing apparatus to perform operations further comprising deleting a part of the composite object according to a motion of a player character.

12. The non-transitory computer-readable storage medium according to claim 11, wherein the information processing further comprises, when the part of the composite object has been deleted, restoring the shape of the composite object to an original shape thereof according to a lapse of time.

13. The non-transitory computer-readable storage medium according to claim 9, wherein
the second part is an object representing an eye of the non-player character.

14. The non-transitory computer-readable storage medium according to claim 9, wherein
the composite object further includes an object that represents a foot of the non-player character.

15. An information processing system, comprising:
one or more processors that are configured to execute information processing comprising:
determining parameters of a position, a rotation, and a scale for each of a plurality of parts; and
generating a composite object including a first part and a second part, the first part having a shape obtained by combining the plurality of parts placed in a virtual space, based on the parameters, the second part being placed at a reference position in the virtual space and being different from the first part, wherein
the parameters are determined such that the reference position is not shielded by the first part on a side in a reference direction of the composite object.

16. An information processing apparatus, comprising:
one or more processors that execute information processing, the information processing comprising:
determining parameters of a position, a rotation, and a scale for each of a plurality of parts; and
generating a composite object including a first part and a second part, the first part having a shape obtained by combining the plurality of parts placed in a virtual space, based on the parameters, the second part being placed at a reference position in the virtual space and being different from the first part, wherein
the parameters are determined such that the reference position is not shielded by the first part on a side in a reference direction of the composite object.

17. An information processing method performed on an information processing system, the information processing method comprising:
determining parameters of a position, a rotation, and a scale for each of a plurality of parts; and
generating a composite object including a first part and a second part, the first part having a shape obtained by combining the plurality of parts placed in a virtual space, based on the parameters, the second part being placed at a reference position in the virtual space and being different from the first part, wherein
the parameters are determined such that the reference position is not shielded by the first part on a side in a reference direction of the composite object.
